(19) United States
(12) Patent Application Publication
(10) Pub. No.: US 2001/0037444 A1
(43) Pub. Date: Nov. 1, 2001

(54) INSTRUCTION BUFFERING MECHANISM

(76) Inventors: KENNETH K. MUNSON, SARATOGA, CA (US); SEAN P. CUMMINS, SUNNYVALE, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/148,638

(22) Filed: Sep. 4, 1998

(51) Int. Cl. G06F 9/00

(52) U.S. Cl. 712/207; 712/239

(57) ABSTRACT

A novel instruction processing system for processing branch instructions and fetching instructions from an instruction memory. Branch instructions are then predicted. If a branch instruction is predicted taken, a block of instructions beginning at the jump target address is fetched and stored in an instruction queue directly following the branch instruction so that multiple streams of instructions are stored in the instruction queue.

### CROSS REFERENCE TO RELATED APPLICATION

This application is related to the following, commonly assigned U.S. patent application, which is incorporated entirely by reference herein:

Ser. No. 09/______ , filed Sep. 4, 1998, entitled “Improved Branch Prediction Mechanism,” by Sean P. Cummins et al.

### BACKGROUND OF THE INVENTION

The present invention relates to a branch instruction prediction and fetching mechanism used in a computer. Specifically, the branch instruction prediction and fetching mechanism improves performance of branch instruction execution in both scalar and superscalar processor designs.

Computers process information by executing a sequence of instructions, which may be supplied from a computer program written in a particular format and sequence designed to direct the computer to operate a particular sequence of operations. Most computer programs are written in high level languages such as C language which is not directly executable by the computer processor. These high level instructions are translated into instructions, for example: assembly languages, having a format that can be decoded and executed within the processor.

Instructions are conventionally stored in data blocks having a predefined length in a computer memory element, such as main memory or an instruction cache. These instructions are fetched from the memory elements and then supplied to a decoder, in which each instruction is decoded into one or more instructions having a form that is executable by an execution unit in the processor.

Pipelined processors define multiple stages for processing a instruction. These stages are defined so that a typical instruction can complete processing in one cycle and then move on to the next stage in the next cycle. In order to obtain maximum efficiency from a pipelined processing path, the decoder and subsequent execution units must process multiple instructions every cycle. Accordingly, it is advantageous for the fetching circuits to supply multiple new instructions every cycle. In order to supply multiple instructions per clock, a block of instruction code at the most likely subsequent execution location is fetched and buffered so that it can be supplied to an instruction decoder when requested.

In order for a pipelined microprocessor to operate efficiently, an instruction fetch unit at the head of the pipeline must continually provide the pipeline with a stream of microprocessor instructions. However, conditional branch instructions within an instruction stream prevent the instruction fetch unit from fetching subsequent instructions until the branch condition is fully resolved. In pipelined microprocessor, the branch condition will not be fully resolved until the branch instruction reaches an instruction execution stage near the end of the microprocessor pipeline. Accordingly, the instruction unit will stall because the unresolved branch condition prevents the instruction fetch unit from knowing which instructions to fetch next.

To alleviate this problem, many pipelined microprocessors use branch prediction mechanisms that predict the existence and the outcome of branch instructions within an instruction stream. The instruction fetch unit uses the branch predictions to fetch subsequent instructions. For example, Yeh & Patt introduced a highly accurate two-level adaptive branch prediction mechanism. (See Tsu Yu Yeh and Yale N. Patt, Two-Level Adaptive Branch Prediction, The 24th ACM/IEEE International Symposium and Workshop on Microarchitecture, November 1991, pp. 51-61) The Yeh & Patt branch prediction mechanism makes branch predictions based upon two levels of collected branch history.

FIG. 2 shows a conventional instruction processing mechanism 210 comprises an instruction cache 220 for storing instruction data, an instruction queue 230 storing a stream of instructions waiting for processing in the processing pipelines, and a branch instruction buffer 240 for temporarily storing fetched subsequent instructions predicted by a branch prediction mechanism. The branch instruction buffer 240 is for temporarily storing the fetched subsequent instructions predicted by the branch prediction mechanism. The next branch instruction located in the instruction queue 230 is predicted. When a jump is predicted by the branch prediction mechanism for the next branch instruction, a block of the subsequent instructions beginning at the target address is fetched from the instruction cache 220 and stored in the branch instruction buffer 240. When the instruction pointer for the processing pipeline(s) reaches the branch instruction address, the entire block of instruction stored in the branch instruction buffer 240 is loaded into the instruction queue 230. Because of the time needed to move the instruction data from the branch instruction buffer 240 to the instruction queue 230, an at least one clock cycle is wasted in the instruction pipeline so that the processing pipeline is idled during the at least one clock cycle. This timing delay is undesirable and affects the operating efficiency of the processing system.

U.S. Pat. No. 5,408,885 issued to Gupta et al. on Mar. 4, 1997 (“Gupta”) discloses another method of resolving this problem. As shown in FIG. 3, Gupta's instruction processing mechanism 310 comprises an instruction cache memory 320, an instruction queue 330 and a branch instruction buffer 340 as in FIG. 1. However, instead of loading the fetched instruction data from the branch instruction buffer 340 to the instruction queue 330, Gupta's instruction processing mechanism further comprises a multiplexer 350. The multiplexer 350 controls the source of the instruction data provided to the processing pipeline(s) (not shown). When a jump is predicted for the branch instruction, the instruction data is fetched and stored in the branch instruction buffer 340. After the branch instruction is processed and predicted taken, the jump target and subsequent instructions are then provided to the processing pipeline(s), instead of providing from the instruction queue 330. Instead of incurring extra clock cycles to move instruction data from the branch instruction buffer 340 into the instruction queue 330 as in the system shown in FIG. 2, the Gupta's system uses the multiplexer 350 to select instruction data between the two instruction data sources (i.e. either from the instruction queue 330 or the branch buffer 340). The additional time required to control the multiplexer 350 for selecting the appropriate data path creates a timing delay in the instruction data path.

Furthermore, the timing delay is exacerbated by the locating of the multiplexer 350 in the critical data path between the branch instruction buffer 340 and the processing pipeline(s). Since all the instruction data needs to pass through the multiplexer 350 before being decoded and assigned by the instruction queue controller, this additional timing delay caused by the multiplexer incurs a large performance penalty on the entire instruction processing system.

Therefore, a novel method of handling predicted branch instructions is needed.

Additional objects, features and advantages of various aspects of the present invention will become apparent from the following description of its preferred embodiments, which description should be taken in conjunction with the accompanying drawings.

### SUMMARY OF THE INVENTION

It is, therefore, the object of the present invention to provide a novel instruction processing system.

It is another object of the present invention to provide an instruction queue management mechanism for an instruction processing system.

It is a further object of the present invention to provide an instruction queue management mechanism capable of working with a branch prediction mechanism.

It is another object of the present invention to provide an instruction queue management mechanism that is able to avoid an at least one clock cycle delay when a branch instruction is processed.

The present invention comprises: an instruction cache for storing instructions waiting to be processed, at least one processing pipeline(s) for processing the instructions, an instruction controller for fetching instructions from the instruction cache memory and assigned the fetched instructions to the processing pipeline for processing. The instruction controller of the present invention comprises an instruction queue for arranging the fetched instructions in a proper sequence for processing. The instruction controller further comprises a branch prediction mechanism for predicting the results of any branch instruction located in the instruction stream.

The instruction controller of the present invention further comprises an instruction queue controller working with the branch prediction mechanism. When a branch instruction is detected, the branch condition is predicted by the branch prediction mechanism so that the instruction queue controller loads the instruction queue with instructions beginning at the jump target address of the branch instruction.

### BRIEF DESCRIPTION OF THE DRAWINGS

FIG. 1 shows an instruction processing system having an instruction cache memory, an instruction controller and two processing pipelines.

FIG. 2 shows a conventional branch instruction processing mechanism.

FIG. 3 shows another conventional branch instruction processing mechanism.

FIG. 4 shows yet another conventional branch instruction processing mechanism.

FIG. 5 shows an instruction processing mechanism of a preferred embodiment of the present invention.

FIG. 6 shows an instruction processing mechanism of another preferred embodiment of the present invention.

FIG. 7 shows the details of an instruction queue of a preferred embodiment of the present invention.

FIG. 8 shows a flow chart showing one method of implementing the instruction processing system of the present invention.

### DETAIL DESCRIPTION OF THE DRAWINGS

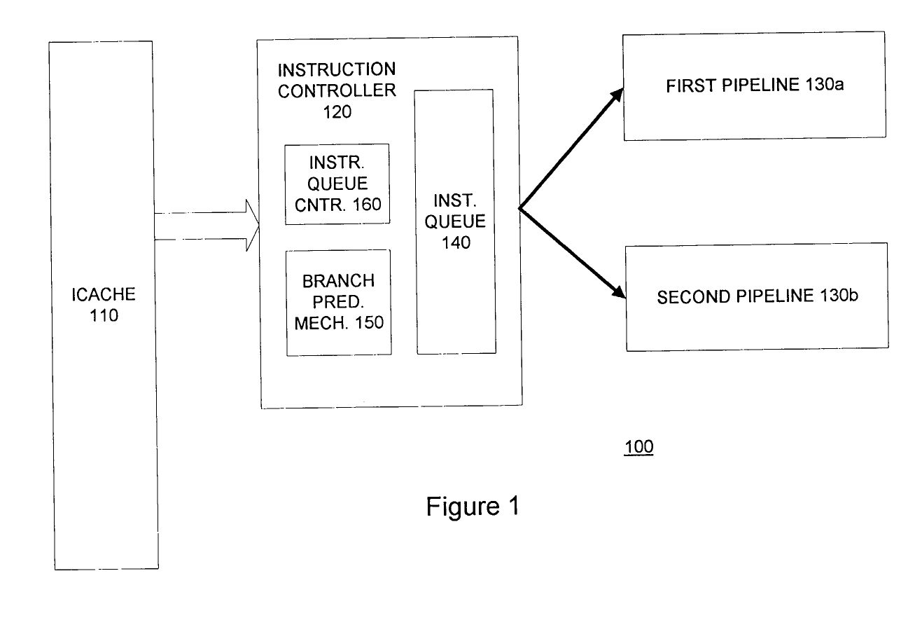

FIG. 1 shows a conventional instruction processing system 100. The instruction processing system 100 as shown comprises an instruction cache 110 for storing instruction data, an instruction controller 120 for fetching instructions from the instruction cache 110 and then assigning the fetched instructions to the instruction pipelines 130a, 130b, and two instruction pipelines 130a, 130b for processing the instructions. As shown in the figure, the instruction controller in this design comprises an instruction queue 140 for storing a instruction stream waiting to be decoded and assigned to the processing pipelines 130a, 130b. In addition, the instruction controller 120 further comprises a branch prediction mechanism 150 for handling branch instructions in the instruction stream. The branch prediction mechanism predicts the result for each branch instruction and fetches the subsequent instructions from the instruction cache memory 110 (or main memory).

In some designs, a branch instruction buffer is used with the branch prediction mechanism to assist the handling of branch instructions. When a branch instruction is predicted to be taken, a block of instructions following the jump target address of the branch instruction is fetched from the instruction cache memory and stored in the branch instruction buffer. After the branch instruction stored in the instruction queue is decoded and assigned to one of the processing pipeline(s), the entire block of instructions stored in the branch instruction buffer is moved into the instruction queue so that the instruction at the jump target address will be the next instruction to be decoded and assigned.

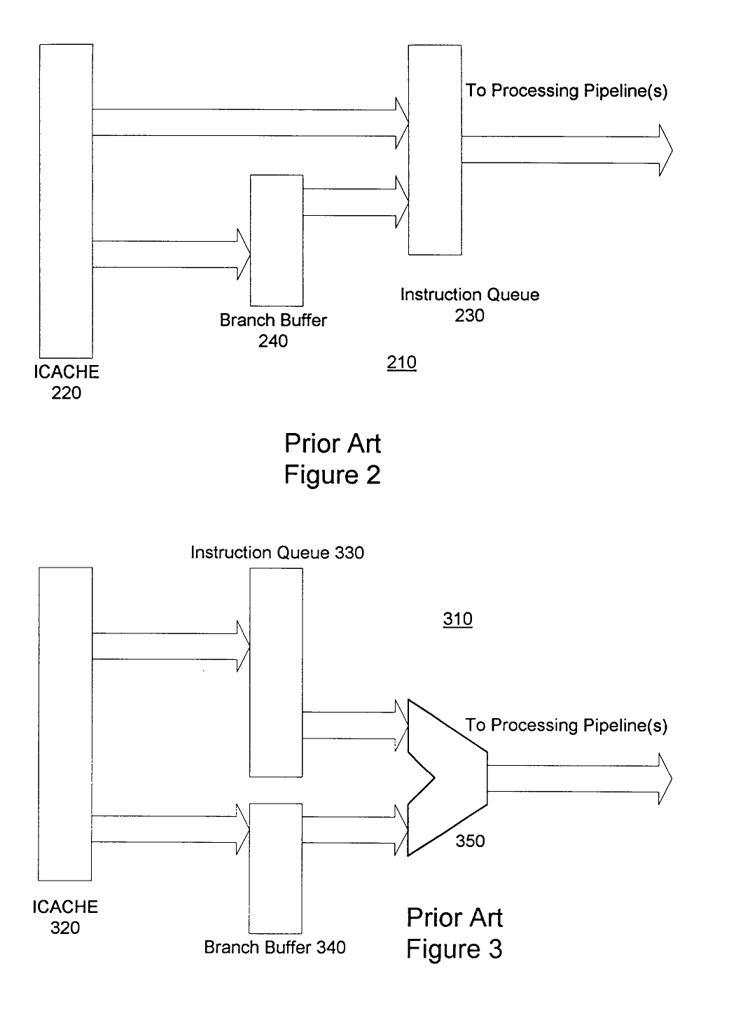

FIG. 2 is a block diagram showing a conventional instruction processing system 210 employing a branch instruction buffer 240 working with a branch prediction mechanism (not shown). The instruction processing system 210 as shown comprises an instruction cache memory 220, an instruction queue 230, and a branch instruction buffer 240. In this system, instructions are usually fetched from the instruction cache memory 220 and stored in the instruction queue 230. The instructions stored in the instruction queue 230 are arranged and assigned to any one of the instruction pipelines. In this design, the branch instruction buffer 240 is placed between the instruction cache memory 220 and the instruction queue 230. As discussed in the previous paragraph, the branch instruction buffer 240 is used for storing block(s) of the instructions beginning at the jump target address of the next predicted taken branch instruction in the instruction streams. However, as stated in the previous paragraphs, this design also suffers various timing and performance problems.

FIG. 3 shows another instruction processing system 310 as disclosed by U.S. Pat. No. 5,408,885 issued to Gupta et al. on Mar. 4, 1997 (“Gupta”). Similar to the instruction processing system 210 as shown in FIG. 2, Gupta's system comprises an instruction cache 320, an instruction queue 330, and a branch instruction buffer 340. When a branch instruction is predicted taken, a block of instructions beginning at the jump target address of the branch instruction is fetched from the instruction cache memory 320 and stored in the branch instruction buffer 340. In the Gupta's system, a multiplexer 350 is used for selecting instruction data from the instruction queue 330 and the branch buffer 340. After the branch instruction stored in the instruction queue 330 is assigned to the processing pipeline(s), the multiplexer will be selected so that the subsequent instructions (i.e. assuming the branch instruction is predicted Taken) will be provided to the processing pipeline(s) from the branch instruction buffer 340. Therefore, instructions beginning at the jump target address can then be continually provided to the processing pipeline(s) from the branch instruction buffer 340. As stated in the background of the invention, however, additional timing delays are caused by the multiplexer 350 in selecting between the dual instruction data paths (i.e. from the instruction queue 330 or the branch instruction buffer 340).

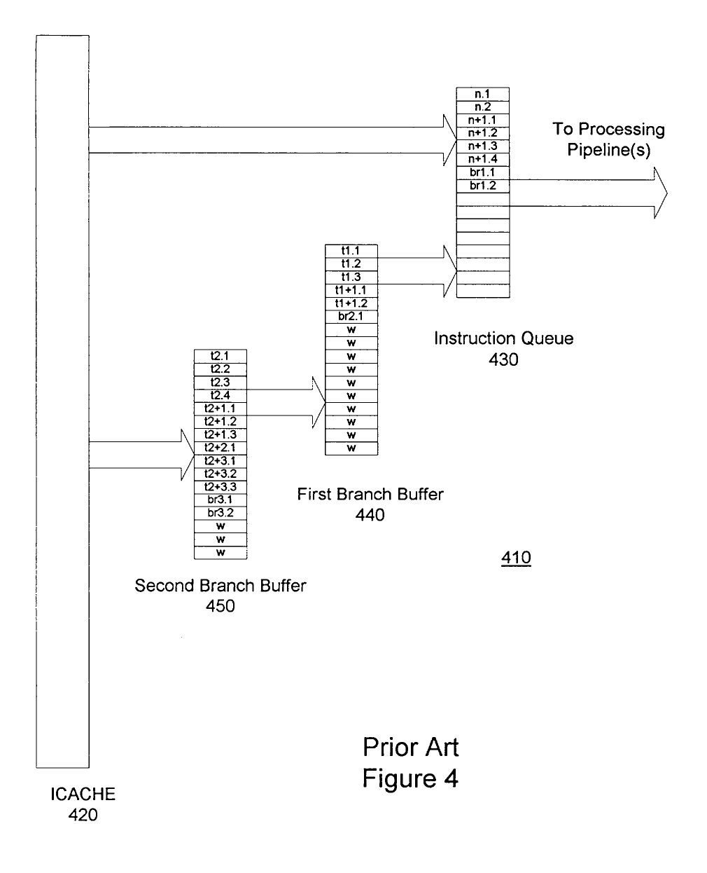

FIG. 4 shows another conventional instruction processing system 410 employing multi-level branch instruction buffers. The instruction processing system 410 as shown comprises an instruction cache memory 420, an instruction queue 430 for providing instructions to the processing pipelines, and two branch instruction buffers 440, 450. In the system as shown, each of the two branch instruction buffers 440, 450 comprises a fixed number of storage elements. Each of the storage elements is one byte long and stores either an entire instruction (i.e. single byte instruction) or a portion of an instruction (i.e. instruction that takes more than one byte). It should be noted that the number of byte per instruction is not fixed. The number of byte per instruction ranges from one to fifteen, or possibly more.

For example, in the instruction queue 430 as shown, the first instruction n is two bytes long and stored by the first two storage element (i.e. n.1, n.2). The second instruction n+1 is four bytes long, and is stored in the next four storage elements (i.e. n+1.1, n+1.2, n+1.3, n+1.4). In the example as shown, the third instruction stored in the instruction queue 430 is a branch instruction br1 where the instruction of the jump target address is the instruction t1. As shown in the FIG. 4, the branch instruction br1 occupies two storage elements (i.e. br1.1, br1.2).

As discussed in the previous paragraphs, this conventional design employs the first branch buffer 440 to store an instruction block beginning at the jump target address t1. Therefore, the first branch buffer 440 as shown in FIG. 4 stores a block of instructions beginning at the jump target address t1. In the example as shown, the instruction t1 is 3 bytes long, and occupies the first three storage elements of the first branch buffer(i.e. t1.1, t1.2, t1.3). The second instruction t1+1 is two bytes long and occupies the following two storage elements of the first branch buffer (i.e. t1+1.1, t1+1.2). The third instruction is another branch instruction br2, and is only one byte long (i.e. br2.1).

In this example, the predicted target address of this branch instruction br2 is the instruction t2. A block of instructions are then fetched from the instruction cache memory 420 and stored in the second branch buffer 450. Therefore, the second branch buffer 450 stores the block of instructions beginning at the second jump target address t2. In the example as shown, the instruction t2 is 4 bytes long, and occupies the first four storage elements of the second branch buffer 440 (i.e. t2.1, t2.2, t2.3, t2.4). The second instruction is three bytes long, and occupies the following three storage elements (i.e. t2+1.1, t2+1.2, t2+1.3). It should be noted that the last instructions stored in the second branch buffer 450 is another branch instruction br3. Since there are only two branch buffers 440, 450 in this design, the predicted jump target instructions of the branch instruction br3 are not pre-fetched from the instruction cache memory 420.

Since the storage elements of the instruction queue 430 and the two branch instruction buffers 440, 450 following any of the predicted “taken” branch instructions are not used, the portion of the instruction queue 430 and the branch instruction buffers 440, 450 after a predicted taken branch instruction are always wasted. These area are indicated as “w” in the figure. As shown in the figure, the first branch buffer 440 is only partially filled until the second branch instruction br2.1. Similarly, the second branch buffer 450 is also partially filled until the third branch instruction br3.2. The remaining storage of the two branch buffers 440, 450 are not filled with any new data. These wasted storage causes inefficient use of the instruction queue 430 and the branch instruction buffers 440, 450.

In this design, the instruction queue 430 is handled by a queue controller (not shown in the figure) for decoding and assigning the instructions to the corresponding processing pipeline(s). It should be pointed out that, for the system as shown, the queue controller is designed to handle only a fixed number of storage elements in the instruction queue 430. The complexity of the queue controller design is proportional to the number of the storage spaces in the instruction queue 430 and each of the branch instruction buffers 440, 450. The more the storage elements available in the instruction queue 430, the more complex is the queue controller. Therefore, in the conventional design, the number of storage elements in the instruction queue 430 and each of the branch instruction buffers 440, 450 are severely constrained and small. For example, in the system as shown in the figure, each of the instruction queue 430 and the two branch instruction buffers 440, 450 comprises 16 storage elements. The queue controller of the system as shown in the figure is then designed to handle only 16 storage elements.

A shortcoming of this conventional instruction processing design is that when this conventional instruction processing design is used in a superscalar processor system (i.e. more than one processing mechanism), the instruction queue 430 might not be able to store all the instructions needed to be assigned to all processing pipelines.

For instance, assuming there are three processing pipelines in a superscalar system used with the processing system as shown in FIG. 4. In order to fully utilize the three processing pipelines, the queue controller decodes three instructions stored in the instruction queue, and then assigns each of the three instructions to one of the instruction processing pipelines. However, in some instances, some instructions can be as long as fifteen bytes, and occupies fifteen storage elements. In this case, the instruction queue 430 stores less than three instructions and is unable to decode and feed one instruction to each instruction processing pipeline. Therefore, in order to fully utilize all three processing pipelines, new instructions are needed to be moved into the instruction queue 430 from the instruction memory 420. However, this creates a tremendous delay in the handling of long instructions because of the time required to move the instructions into the instruction queue 430.

The other disadvantage of this instruction processing system design is the time delay required to move the instruction data from the branch buffers 440, 450 to the instruction queue 430 after the branch instruction is decoded and assigned to the processing pipeline. For example, in the system as shown in FIG. 4, after the branch instruction br1 is decoded and predicted, the block of instructions beginning at the first jump target address (i.e. t1) is needed to be moved from the first branch buffer 440 to the instruction queue 430. However, this process always requires at least one clock cycle. Therefore, there is always at least one cycle delay from the execution of the first branch instruction and the predicted first jump target address instruction.

Another disadvantage of this design is the limitation of the number of the branch instructions handled by this design. The number of branch instructions for this design is limited by the number of branch instruction buffers 440, 450 available in the system 410. In the present illustrated case, only two-level branch instruction prediction is allowed because only two branch instruction buffers (i.e. first branch buffer 440, and second branch buffer 450) are available.

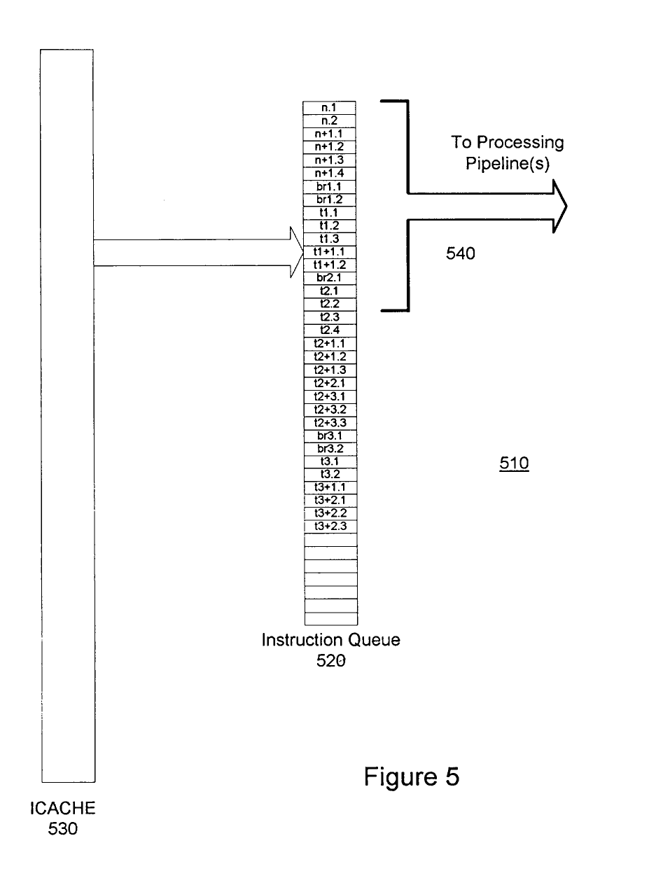

FIG. 5 shows a block diagram illustrating an instruction processing system 510 of a preferred embodiment of the present invention. It should be noted that the instruction sequence of this instruction processing system is similar to the one as shown in FIG. 3.

In the preferred embodiment as shown, the instruction processing system comprises only one extended instruction queue 520 comprising forty storage elements. Similarly to the conventional systems as shown, each of the forty storage elements is one byte long. A similar instruction queue controller as in the conventional design as shown in FIG. 4 is used with the extended instruction queue 520 of this preferred embodiment. However, it should be emphasized that the extended instruction queue of the present embodiment has substantially more storage elements (e.g. 40) than the conventional system (e.g. 16). In this embodiment, the instruction queue controller only decodes and assigns the instructions contained in the top sixteen storage elements. Therefore, an instruction processing window 540 of sixteen storage elements long is conceptually defined at the top of the instruction queue 520. Within this sixteen storage elements instruction processing window 540, the top three instructions are decoded and assigned to the processing pipelines. After the top three instructions are decoded and assigned, all the instructions stored in the instruction queue 520 shifted up and purged the top three instructions out from the instruction queue 520. After that, the instruction queue controller continues to process the instructions stored in the top sixteen bytes of the instruction queue.

It should be noted that, in the present invention, the instruction data is not limited to be fetched from the instruction cache memory 530 alone. In some instances, the instruction data is fetched from the main memory of the system if the required data is not available in the instruction cache memory 530.

In the preferred embodiment as shown, the instruction queue 520 is preferably constructed from a group of shift registers, or a first-in-first-out queue (“FIFO”). When the instructions on the top of the instruction queue 520 are assigned to the pipelines, all the instruction data stored in the instruction queue 520 are shifted up. After the instruction data are shifted to the top and empty instruction storage elements are created at the bottom of the instruction queue 520, instruction data are then read from the instruction cache memory 520 (or main memory) and stored into the instruction queue 530.

When a branch instruction is processed, the branch condition is first predicted by a branch prediction mechanism (not shown). When the branch condition is predicted to be taken, the block of instructions beginning at the jump target instruction is fetched from the instruction cache 530 (or main memory) and stored in the instruction queue 520 after the branch instruction. By storing these instructions after the branch instruction, the original instructions originally following the branch instruction are overwritten.

Therefore, in the preferred embodiment as shown, when the branch condition is finally resolved and the predicted result is determined to be incorrect, the original block of instructions is then required to be re-fetched from the instruction cache. Since most of the predicted results are correct, the possible delay of an incorrect predicted jump is very limited.

As shown in the figure, because the block of instructions following the jump target address is fetched and stored right after the branch instruction, the number of branch instructions is not limited by the number of buffers as shown in FIG. 3.

Because the block of instructions has been fetched and stored in the instruction queue, the instructions following the branch instruction are immediately available for the processing pipeline(s) after the branch instruction is assigned. The elimination of the process to move the instructions from the branch buffer 440 (as in the system as shown in FIG. 4) to the instruction queue 430 reduces at least one cycle every time it processes a branch instruction.

Furthermore, the wasted storage in the branch buffers 440, 450 as indicated by “w” in FIG. 4 can be totally eliminated by the preferred embodiment as shown in FIG. 5 because the instruction data are compacted and stored in the instruction queue 520. For example, as shown in FIG. 5, the instruction t1 is located right after the first branch instruction br1. Similarly, the instruction t2 is located right after the second branch instruction br2.

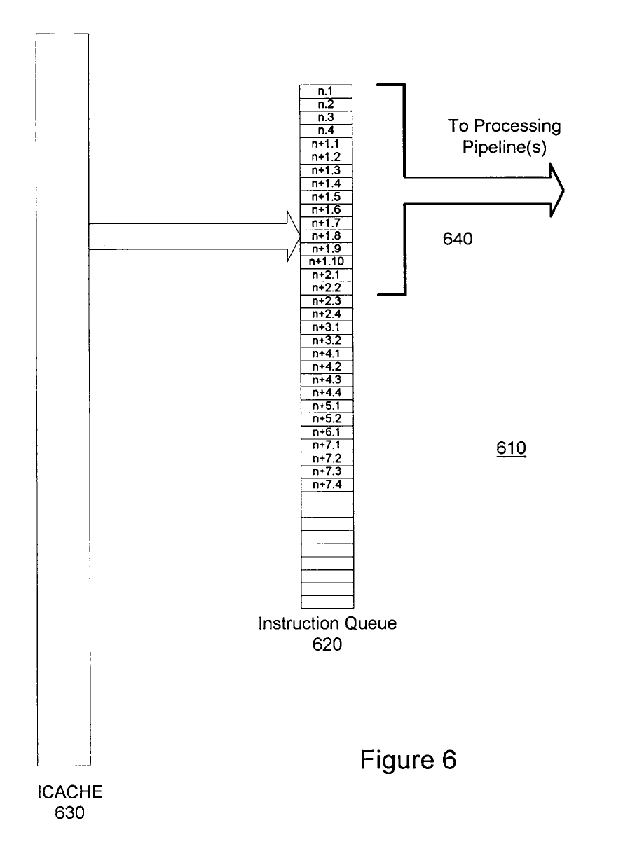

Another advantage of having the extended instruction queue having a substantially more storage elements than the conventional design is to eliminate and avoid the performance penalties suffered from processing long instructions. As discussed in the previous paragraph, the conventional instruction queue sometimes may not be able to store all three instructions when the instructions are long (e.g. 10 bytes instruction). Time is then required to move instructions from the instruction cache to the instruction queue. Instead of waiting for the instructions to be fetched from the instruction cache memory, the present invention simply shifts the instruction stored in the instruction queue 520 up when the instructions are need outside the instruction processing window 540 (i.e. top 16 bytes of the instruction queue). By simply shifting up the contents in the instruction queue 520, the instruction queue controller does not need to wait for a new block of instruction data to be fetched from the instruction cache 530. This advantage can be exemplified in the system as shown in FIG. 6.

The instruction queue of the preferred embodiment as shown in FIG. 6 contains a sequence of instructions. The first instruction n is 4 bytes long (i.e. n.1, n.2, n.3, n.4). The second instruction is 10 bytes long (i.e. n+1.1, n+1.2, n+1.3, n+1.4, n+1.5, n+1.6, n+1.7, n+1.8, n+1.9, n+1.10). The third instruction is 4 bytes long (i.e. n+2.1, n+2.2, n+2.3, n+2.4). An instruction queue controlling window 640 of sixteen bytes lone is created by the instruction queue controller (not shown) at the top of the instruction queue 620. It can be seen that the top three instructions (i.e. n, n+1, n+2) occupies more than sixteen bytes of the instruction queue 620. Therefore, the instruction queue controlling window 640 only covers the first two instructions (i.e. n, n+1) and a portion of the third instruction (i.e. n+2).

Therefore, in this present embodiment, after the first two instructions are read into the instruction queue controller, all the storage elements of the instruction queue 620 are shifted up (e.g. to purge out the first two instructions) so that the third instruction can enter the instruction queue controlling window 640 and can be read by the instruction queue controller. By simply shifting up the storage elements, the present invention eliminates the time required to read the instructions from the instruction cache memory 620.

Another advantage of having the extended instruction queue as disclosed in the present invention is the decoupling of (1) the fetching of instructions from the instruction cache memory (or main memory) 530, 630 to the instruction queue 520, 620 and (2) the decoding of instructions currently stored in the instruction queue 520, 620 and the subsequent assigning of these instructions to the processing unit(s). By having more storage elements in the instruction queue 520, 620 than covered by the instruction queue controlling window 540, 640, the extended instruction queue 520, 620 can act as a buffer between these two processes so that the instruction fetches can continue even if there is a processing stall in any of the processing unit(s).

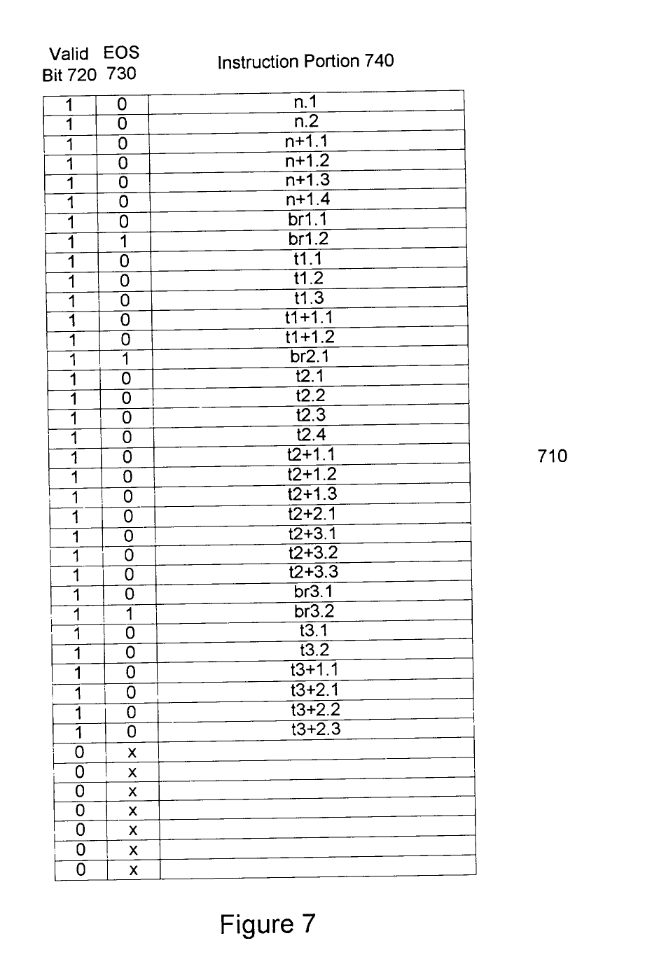

FIG. 7 shows a block diagram of the instruction queue 710 of the preferred embodiment of the present invention as shown in FIG. 5. In the instruction queue of the preferred embodiment as shown, each of the storage elements of the instruction queue comprises an instruction portion 740 for storing one byte of instruction, a valid bit portion 720 to indicate whether the instruction data is valid; and an end of sequence bit 730 (i.e. EOS) portion for indicating whether the corresponding entry is the end of a current instruction sequence.

It should be noted that the instruction data stored in the instruction portion of the instruction queue 710 as shown in FIG. 7 is based on the same sequence of instructions stored in the instruction queue and two instruction buffers (i.e. first instruction buffer 440 and second instruction buffer 450) as shown in FIG. 4.

As described in the previous paragraphs, the instruction queue 710 is made of a sequence of shift registers. The valid bit is used for indicating the end of the valid data so that newly fetched data can be appended at the end of all the valid data. For example, as shown in FIG. 6, the most recently fetched data ends at t3+2.3 so that the next fetched instructions will be appended after the instruction t3+2.3.

In this preferred embodiment, the EOS bit 730 is used for signaling the end of the current sequence of instructions. For example, in the present example as shown in FIG. 6, the EOS bits are on in the instructions br1.2, br2.1, br3.2, that all are at the ends of a sequence of instructions. This EOS bit is used by the queue controller to detect the ending of the sequence of instructions. Since the instructions have not been fetched after the instruction t3+2.3, the “x” in this EOS bits are marked as “don't care.”

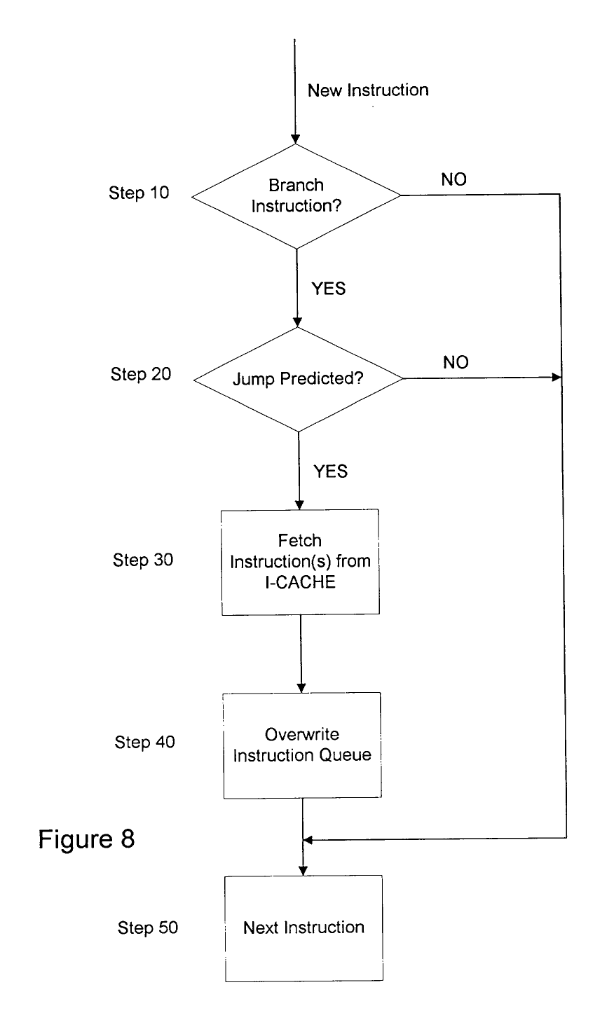

FIG. 8 shows a simple flow chart for one embodiment of the present invention.

When a new instruction is processed by the instruction processing system of the present invention, a determination is performed to determine whether the current instruction is a branch instruction (Step 10). If it is a branch instruction, the branch condition is predicted (Step 20).

If the branch instruction is predicted to be non-taken, the following steps are skipped.

On the other hand, if the branch instruction is predicted to be taken, a block of the instructions beginning from the jump target address is fetched from the instruction cache (or the main memory) (Step 30). The block of instructions is then stored in the instruction queue overwriting the instructions originally following the branch instruction (Step 40). After the predicted branch is taken, the next instruction is processed (Step 50).

As discussed in the previous paragraph, if the branch condition is finally determined to be incorrectly predicted, all the instructions beginning at the jump target address will be needed to be flushed from the processing pipeline. However, if the branch condition is determined to be correctly predicted, the stream of the instructions will be processed without any interruption.

It is to be understood that While the invention has been described above in conjunction with preferred specific embodiments, the description and examples are intended to illustrate and not limit the scope of the invention, which is defined by the scope of the appended claims.

What is claimed is:

1. An instruction processing system, comprising:
an instruction memory for storing instructions, said instructions comprising branch instructions and non-branch instructions, each of said branch instructions referring to a corresponding target instruction;
at least one processing unit for processing the instructions stored in said instruction memory;
an instruction queue having a first number of storage spaces, each of the storage spaces storing at least a portion of the instructions, wherein each of the instructions stored in the instruction queue is fetched from said instruction memory;
an instruction queue processing window defining a second number of storage spaces of the instruction queue, wherein said first number is greater than the second number; and
an instruction queue controller for assigning instructions stored in the instruction queue to the processing unit, said instruction queue controller only assigning instructions stored in the storage spaces defined by said instruction queue processing window.

2. The instruction processing system according to claim 1, wherein said instructions stored in the instruction queue comprise at least one branch instruction and at least one corresponding jump target instruction for the branch instruction.

3. The instruction processing system according to claim 2, wherein said instruction queue stores a plurality of streams of instructions, each of said streams comprising at least one instruction.

4. The instruction processing system according to claim 1, wherein the instructions stored in the storage spaces defined by said instruction queue processing window comprise at least one branch instruction and at least one non-branch instruction.

5. The instruction processing system according to claim 4, further comprising a branch prediction mechanism for predicting branch instructions.

6. The instruction processing system according to claim 5, wherein the branch prediction mechanism predicts the result of the branch instruction located in the instruction queue processing window.

7. The instruction processing system according to claim 6, wherein when the branch instruction is predicted to be taken by the branch prediction mechanism, said instruction queue processing window comprises a corresponding target instruction address for said branch instruction.

8. The instruction processing system according to claim 1, wherein said instruction queue comprises a plurality of shift registers.

9. The instruction processing system according to claim 1, wherein said instruction queue is a FIFO (“First In First Out”) buffer.

10. The instruction processing system according to claim 1, wherein said first number is 40.

11. The instruction processing system according to claim 1, wherein said second number is 16.

12. The instruction processing system according to claim 1, wherein said instruction memory comprises an instruction cache.

13. The instruction processing system according to claim 1, wherein each of the said at least one processing unit is a processing pipeline.

14. The instruction processing system according to claim 1, wherein said instruction memory comprises a main memory.

15. The instruction processing system according to claim 1, wherein said instruction memory comprises an instruction cache memory.

16. An instruction processing system, comprising:
an instruction memory for storing instructions, said instructions comprising branch instructions and non-branch instructions, each of said branch instructions referring to a corresponding target instruction;
at least one processing unit for processing the instructions stored in said instruction memory;
an instruction queue having a plurality of storage spaces, each of the storage spaces storing at least a portion of the instructions, wherein each of the instructions stored in the instruction queue is fetched from said instruction memory, and wherein said instructions stored in the instruction queue comprise at least two branch instructions and at least two corresponding jump target instructions for the branch instructions; and
an instruction queue controller for assigning instructions stored in the instructing queue to the processing unit.

17. The instruction processing system according to claim 16, further comprising:
an instruction queue processing window defining a plurality of storage spaces of the instruction queue, wherein the instruction queue processing window does not cover the entire instruction queue.

18. The instruction processing system according to claim 17, wherein said instruction queue controller only assigns instructions within the instruction queue processing window to the processions unit.

19. The instruction processing system according to claim 16 is a superscalar design.

20. The instruction processing system according to claim 16 is a single processor design.

21. The instruction processing system according to claim 16, wherein said instruction queue stores a plurality of streams of instructions, each of said streams comprising at least one instruction.

22. The instruction processing system according to claim 16, wherein said instruction queue is a FIFO (“First In First Out”) buffer.

23. The instruction processing system according to claim 16, wherein each of said at least one processing unit is a processing pipeline.

24. The instruction processing system according to claim 16, wherein said instruction memory comprises a main memory.

25. The instruction processing system according to claim 16, wherein said instruction memory comprises an instruction cache memory.

26. The instruction processing system according to claim 16, wherein the number of the branch instructions stored in the instruction queue is not fixed.

27. An instruction queue comprising:
a plurality of storage spaces storing a plurality of instructions, each of the storage spaces storing at least a portion of one of the instructions, wherein said instructions stored in the instruction queue comprise at least three instruction streams, each of the instruction streams comprising at least one instruction.
